(19) United States
(12) Patent Application Publication
(10) Pub. No.: US 2014/0278936 A1
(43) Pub. Date: Sep. 18, 2014

(54) APPLIANCE CONTROLLER APPLICATION

(71) Applicants: Eric Donald Fescenmeyer, Milwaukee, WI (US); Ryan Michael Johnson Shroat, Schaumburg, IL (US)

(72) Inventors: Eric Donald Fescenmeyer, Milwaukee, WI (US); Ryan Michael Johnson Shroat, Schaumburg, IL (US)

(21) Appl. No.: 14/041,258

(22) Filed: Sep. 30, 2013

Related U.S. Application Data
(60) Provisional application No. 61/794,337, filed on Mar. 15, 2013.

(51) Int. Cl. H05B 1/02; G06Q 30/02; A47J 27/62

(52) U.S. Cl. CPC H05B 1/0261; A47J 27/62; G06Q 30/0255
USPC 705/14.45; 99/325; 219/714

(57) ABSTRACT

A system and method for preparing food products in a programmable appliance such as a microwave includes an appliance configured with a communication element for communicating with a device such as a smartphone, tablet, or computer. The device is configured to scan a product identifier such as a barcode and match the scanned identifier with a list of known identifiers stored in a database. The database associates each of the product identifiers with a product and instructions for cooking the product in the appliance. In another aspect of the invention, a remote server may be provided and configured to receive information from the device such as demographic information relating to the user of the system and the products used thereby.

### CROSS-REFERENCE TO RELATED APPLICATIONS

The present application claims the benefit of priority on U.S. Provisional Patent Application Ser. No. 61/794,337, filed on Mar. 15, 2013 and entitled Microwave Controller Application, the entirety of which is hereby incorporated by reference.

### BACKGROUND OF THE INVENTION

1. Field of the Invention

The present invention relates in general to the field of appliances. More particularly the present invention relates to an application for controlling operation of an appliance such as a microwave.

2. Discussion of the Related Art

Programmable appliances are well known in the art. For example, appliances like the microwave oven have long been used and comprise a number of settings and options for cooking, defrosting, or otherwise preparing food items placed therein. Microwaves typically employ a number of different cooking settings including time, power, mode, and food item specific settings for cooking a particular food item such as for example, microwavable popcorn and the like.

One disadvantage of such appliances is that the complexity of the operating the appliances results in many of the cooking options not being utilized at all or improperly. Accordingly, producers of food products are apt to provide relatively simple cooking instructions, which may be less than optimal for preparation of the particular food product. In some instances, consumers may resort to trial and error to prepare items in the appliance. In either case, the result is food products being prepared in a less than ideal manner. Food products that are improperly prepared may be less pleasing to consume and therefore may result in consumers eschewing the products altogether.

Therefore, what is needed is a method and system of better and more easily preparing food products using a programmable appliance such as for example, a microwave oven.

### SUMMARY AND OBJECTS OF THE INVENTION

According to a first aspect of the present invention, an appliance, such as a microwave is configured to communicate with a controller, which may be in the form of an application operated on a device such as a smartphone, tablet, or other suitable computerized device. The appliance may be configured to communicate via a wireless communication standard to exchange data over a relatively short distance using a short wavelength transmission standard such as, for example, Bluetooth, Wi-Fi, Zigbee, Near-Field Communication, or any other suitable short-range communication standard. The application is configured to use a digital photo or other such readable image of a readable element of an item to be cooked in the appliance. The readable element may be in the form of a barcode or any other suitable element capable of being read and identifying the product associated with the readable element. The product may be, for example, a frozen dinner configured for cooking in the appliance, e.g., a microwave oven. Once the application reads and processes the readable element and determines the product associated with the readable element, the application is configured to communicate with the appliance via the wireless communication standard. The appliance is configured to receive the communication and may include a controller or similar processor configured to program the appliance to cook the product according to the product's associated cooking instructions, which may be stored in a database and transmitted from the application to the appliance, or the appliance may store the database locally and be configured to match the product information transmitted from the application with the corresponding cooking information stored in the database at the appliance.

According to another aspect of the present invention, the application may be configured to transmit product identification information to a remote server. The product identification information may be stored and matched with corresponding consumer information, which may be also collected by the application. In particular, the application may be configured to collect relevant consumer information from the user thereof prior to operation. The consumer information may be transmitted to the remote server and stored. Each time the consumer utilizes the application to identify a product; the relevant information may be transmitted to the remote server and correlated with the consumer information. The resulting information stored at the remote server may then be utilized for carrying out any number of relevant marketing activities to better enable producers of the products to communicate with consumers and understand consumer demographics associated with the various products.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### DESCRIPTION OF THE DRAWINGS

In describing the preferred embodiment of the invention, which is illustrated in the drawings, specific terminology will be resorted to for the sake of clarity. However, it is not intended that the invention be limited to the specific terms so selected and it is to be understood that each specific term includes all technical equivalents, which operate in a similar manner to accomplish a similar purpose. For example, the words “connected”, “attached”, or terms similar thereto are often used. They are not limited to direct connection but include connection through other elements where such connection is recognized as being equivalent by those skilled in the art.

Specific embodiments of the present invention will now be further described by the following, non-limiting examples which will serve to illustrate various features of significance. The examples are intended merely to facilitate an understanding of ways in which the present invention may be practiced and to further enable those of skill in the art to practice the present invention. Accordingly, the examples should not be construed as limiting the scope of the present invention. Note the various inventive elements are shown in several views.

FIG. 1 is a schematic diagram of a system for wirelessly operating and controlling an appliance via an application;

FIG. 2 is a product identification element usable with the application of FIG. 1; and

FIG. 3 is a block diagram of a marketing system according to one aspect of the present invention.

### DETAILED DESCRIPTION

Referring now to the Drawings and FIGS. 1 and 2, a system 20 according to the present invention includes an appliance 22, which may be in the form of a microwave oven, oven, or other such cooking appliance. While the system 20 of the present invention is not necessarily limited to microwave ovens, for the sake of simplicity, the remainder of the detailed description shall describe the appliance 22 in terms of a conventional microwave oven; it is to be understood, however, that the appliance 22 may be any suitable cooking appliance or device capable of being configured in the manner described hereinafter for carrying out the system 20 of the present invention and is not limited to just microwave ovens. The appliance 22 may be configured to incorporate a receiver 24 configured to receive information from a device 26 configured according to the present invention as will be described in additional detail herein. The appliance 22 may further comprise a controller 28 configured to carry out cooking operations of the appliance 22 according to information received from the device 26 as will be described.

The device 26 may be in the form of any type of computerized electronic device capable of carrying out the objectives of the present invention as will be described. In particular, the device 26 may comprise a smartphone, tablet, laptop computer, personal computer, or any other suitable electronic device. The device 26 may include a transceiver 30 capable of transmitting information and receiving information. The transceiver 30 may be configured to operate over a wireless network such as RF, Wi-Fi, Bluetooth, Zigbee, Near-Field Communication, or any other suitable short-range communication standard. While the device 26 is described as communicating over a wireless network, it is understood that the device 26 may be over a suitable wired connection. The device 26 may further comprise a controller 32 or similar arrangement configured to process information received or inputted into the device 26. The device 26 may additionally include memory 34 for storing information. The memory 34 may be that which is already provided by the device 26 or may be in the form of a removable storage medium. The memory 34 may be configured to store an application for carrying out the operations of the device 26 for the system 20 according to the present invention.

The device 26 may include a reader 36 such as a digital camera or the like. The reader 36 may be integrally provided with the device 26, provided remotely therefrom and configured to communicate via a network with the device 26, or connected to the device 26 directly via a wired or wireless connection. The reader 36 is configured to capture an image of a product identification element 38, which is shown in the form of a standard barcode. Understandably, the product identification element 38 may be in the form of any digitally readable configuration and the system 20 is not limited to barcodes but includes any similar types of readable elements known in the art.

Once the product identification element 38 has been captured by the reader 36, the application run in the memory 34 processes the product identification element 38 and compares it to a number of known product identification elements stored in a product database 40, which is shown remote from the device 26 but which may be stored within the memory 34. Once the scanned product identification element 38 has been matched with a known product information element, the product cooking instructions associated with the product identification element 38 may be communicated from the product database 40 to the device 26. The product cooking information received from the product database 40 may then be transmitted from, the device 26 to the reader 24 of the appliance 22. The controller 28 may be configured to process the cooking information received by the reader 24 and program the appliance 22 according to the cooking instructions provided by the product database 40. For example, if the instructions for the product associated with the product identification element 38 require a cooking time of two minutes and thirty seconds, the product database 40 will associate that cooking time with the product associated with the product identification element 38. Once the product identification element 38 is matched with the appropriate product stored in the product database 40, the cooking time information is communicated to the device 26, which then transmits a signal to the appliance 22 to set the appliance 22 cook time to two minutes and thirty seconds. Understandably, any number of alternative arrangements is envisioned in carrying out the current invention. For instance, the product database 40 may be stored within memory (not shown) provided on the appliance 22, and therefore the present invention is not limited to that which is described herein but also covers other methods of carrying out the objectives of the invention known in the art.

In an alternative arrangement of the system 20, the device 26 may be omitted. In the present embodiment, the appliance 22 may include the reader 36, e.g., a barcode scanner, configured to read the product identification element 38 of the product. The product database 40 may then also be incorporated into the appliance 22 such that when the product identification element 36 is scanned, the collected information is sent to the product database 40 stored within memory of the appliance 22 and matched. The controller 28 of the appliance 22 may then be configured to program the appliance 22 to a cook time associated with the product of the product identification element 38. In the alternative, the appliance 22 could include a Wi-Fi or similar type of connection whereby the appliance 22 can automatically download the cooking instructions associated with the identified product rather than storing the information locally. In the case where the cooking instructions are stored locally, the system 20 may be configured to periodically update the instructions in a predetermined manner or may be instructed to update its stored information by the user.

Understandably, the appliance 22 may be programmed in a variety of alternative ways in this and the previous embodiment. For instance, the cooking instructions associated with the product may call for a particular power setting of the appliance 22 to be used. Such cooking instructions may also be incorporated into the system 20 of the present invention.

The system 20 may further comprise a server 42 or other remote electronic storage device known in the art. The server may be configured to communicate wirelessly or via a standard wired connection with the application stored in the memory 34 of the device 26. In particular, the application of the present invention may automatically transmit information to the server, which may be used by producers of the appliance 22, the device 26, the product associated with the product identification element 38, marketing research films, and the like. For instance, the application carried by the memory 34 may require the user of the system 20 to enter certain demographic information including age, sex, income, and the like prior to utilizing the application for the first time or at any point subsequent thereto. The information collected by the application and transmitted to the server 42 may be stored at the server for a number of uses including targeted marketing or the like. The application of system 20 may also be configured to transmit product information collected by the application to the server 42. For instance, after each time a user scans a product identification element 38 and the associated product information is matched from the product database 40; such product information may be transmitted to the server 42 and linked with the stored user information for subsequent use as may be desired.

Referring now to FIG. 3, according to another aspect of the present invention, the system 20 of the present invention may be used by a provider of the system 20 for marketing to users of the system 20. In a first step 44, the user of the system registers by providing his or her demographic information that the device 26. This may include information such as the user's age, sex, marital status, household information, or the like. This information may be stored within the memory 34 of the device 26 in a second step 46. In addition, this information may then be transmitted to the server 42 and saved for subsequent usage. Next, in a third step 48, the user subsequently scans the product information as previously described herein. Such product information may include a product barcode 38 or similar such identifier. The scanned product information is transmitted to the server 42 and associated with the user information collected in the second step 46 in a fourth step 50. Finally, using the collected user information and product information the system 20 may provide targeted advertising on any device 26 in a fifth step 52. The targeted advertising may be configured to provide advertisements to the user of the system 20 corresponding with goods and services typically associated with persons having similar demographic information and which use similar products to the collected product information.

It is intended that the appended claims cover all such additions, modifications, and rearrangements. Expedient embodiments of the present invention are differentiated by the appended claims.

What is claimed is:

1. A system for cooking a food item comprising:
an appliance; and
a device in operable communication with the appliance configured to read a product identifier associated with the food item and transmit a set of cooking instructions associated with the food item to the appliance.

2. The system of claim 1, wherein the appliance is configured to be programmed according to the set of cooking instructions received from the device.

3. The system of claim 1, wherein the appliance comprises a receiver configured to receive signals from the device.

4. The system of claim 3, wherein the receiver is a short-range wireless receiver.

5. The system of claim 1, wherein the device comprises a digital camera configured to read the product identifier.

6. The system of claim 1, further comprising a product database configured to associate a plurality of product identifiers with a corresponding plurality of sets of cooking instructions.

7. The system of claim 1, further comprising a server in operable communication with the device and configured to receive demographic information of a user of the system from the device.

8. The system of claim 7, wherein the server is configured to associate the demographic information with the food item identified.

9. An appliance comprising:
a receiver configured to receive communications of cooking instructions associated with a product from an electronic device; and
a controller configured to program the microwave to cook the product according to the cooking instructions.

10. The appliance of claim 9, wherein the electronic device is a scanner operably coupled to the appliance.

11. The appliance of claim 9, wherein the electronic device is a smartphone running an application stored in a memory of the smartphone and configured to transmit cooking instructions associated with the product.

12. The appliance of claim 9, wherein the receiver is a Bluetooth receiver.

13. The appliance of claim 9, wherein the appliance is a microwave.

14. A method of marketing, comprising the steps of:
registering a user via a program stored on an electronic device;
collecting user data at a server in operable communication with the electronic device;
scanning product information with the electronic device;
associating the product information with the collected user data;
presenting targeted advertisements to the user on the electronic device, corresponding to the user data and scanned product information.

15. The method of marketing of claim 14, wherein the user data comprises demographic information relating to the user.

16. The method of marketing of claim 14, wherein the electronic device comprises a smartphone.

17. The method of marketing of claim 14, wherein the product information comprises at least one of a product bar code and product packaging.

18. The method of claim 14, wherein the associating step comprises saving the product information to the server.

19. The method of claim 14, wherein the associating step comprises the step of matching the product information with stored product information on the server.

20. The method of claim 14, further comprising the step of providing a product database.
